(19) United States
(12) Patent Application Publication
(10) Pub. No.: US 2007/0230106 A1
(43) Pub. Date: Oct. 4, 2007

(54) Disk drive fixing device

(75) Inventor: Yun-Chieh Yeh, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,068

(22) Filed: Mar. 30, 2006

(51) Int. Cl. G06F 1/16

(52) U.S. Cl. 361/685

(57) ABSTRACT

A disk drive fixing device for carrying and fixing a disk drive on a mounting surface, includes a main body for carrying at least one disk drive; and a buffer disposed on one side of the main body, for being indirectly fixed to the mounting surface. The buffer completely covers a fixing portion of the main body, wherein the fixing portion is for being fixed to the mounting surface, and the buffer can be fixed to the mounting surface by a fixer, such that the fixing portion of the main body can be indirectly in contact with the fixer and the mounting surface via the buffer, thereby providing an anti-shock effect for the disk drive indirectly fixed on the mounting surface.

### FIELD OF THE INVENTION

The present invention relates to devices for fixing disk drives, and more particularly, to a fixing device for carrying and fixing a disk drive on a mounting surface.

### BACKGROUND OF THE INVENTION

Computers are considered as most widely used electronic devices. In order to keep up competitiveness in the electronic market, the design, fabrication and assembly of electronic devices must be advanced unceasingly. Thus, any improvement in simplifying the structure, increasing the convenience of assembly, or reducing the fabrication costs of the computers is commercially important in the computer market, which also gives motivation for the present inventor to improve a fixing device for a disk drive.

Along with the development of the computer industry, all elements used in the computer have been made toward miniaturization, preciseness, high functionality and high stability. For a hard disk drive, it is not only reduced in size from 3.5-inch hard disk drive to 2.5-inch hard disk drive, but also the storage capacity thereof is multiplied. As to the design of computer architecture, a certain space is reserved in a computer case to accommodate a disk drive such as soft disk drive or hard disk drive, which is usually mounted and fixed on a carrier device such as a disk drive rack, and the carrier device is then secured to the computer case by screws. Related prior arts include Taiwanese Utility Model Patent Nos. 216664, 371062, and 421278.

Shock and collision are the two most harmful factors affecting the functionality of the disk drive when being in use. In the aforementioned arrangement for fixing the disk drive on the disk drive rack, an anti-shock effect is provided by an anti-shock design of the disk drive. However, as there is no design of a buffer between the disk drive and the disk drive rack, reading and writing processes of the disk drive may easily be affected by unbalanced resonance frequency between the operation of the disk drive and the computer or by external shocks. Such drawback caused by the above arrangement of simply fixing the disk drive on the disk drive rack may not be obvious for a personal or business computer without frequent reading and writing, but is serious for a server with frequent writing and reading. The external shocks or unbalanced resonance frequency easily results in undesirable contact between a read/write head of the disk drive and a disk, such that the disk drive is damaged. Accordingly, the IBM Company has successfully developed an anti-shock technology for a hard disk drive, which can predict drop of the hard disk drive and temporarily remove the read/write head in advance so as to avoid collision between the read/write head and the disk. However, this anti-shock technology is not capable of handling the collision between the read/write head and the disk due to sudden shocks and thus cannot provide a satisfactory anti-shock effect. Moreover, the anti-shock technology utilizes an internal sensor chip to sense unusual shocks, which undesirably increases the costs. Besides, the anti-shock technology of predicting drop of the disk drive and temporarily removing the read/write head in advance can only prevent the collision between the read/write head and the disk, but may not absorb and reduce shocks. Thus, there is still a risk of causing damage to internal components by the drop of the disk drive or the collision. Therefore, it is deemed necessary to develop an anti-shock device for a hard disk drive, as disclosed in Taiwanese Utility Model Patent No. 501781.

FIGS. 1 and 2 show an anti-shock device 1 for a hard disk drive 13 as disclosed in Taiwanese Utility Model Patent No. 501781. The anti-shock device 1 comprises a casing 11 having a base 111 and a lid 113 and for receiving the hard disk drive 13 therein. The anti-shock device 1 further comprises a plurality of anti-shock members 15 disposed between the hard disk drive 13 and the casing 11, wherein the anti-shock members 15 cover the hard disk drive 13 to protect the hard disk drive 13 against external shocks. Each of the anti-shock members 15 comprises a main body 151 and a plurality of posts 153, wherein the posts 153 abut against the hard disk drive 13 and the main body 151 is in contact with the casing 11 to absorb the external shocks.

The aforementioned anti-shock device 1 further comprises a plurality of screws 17, and the hard disk drive 13 has a plurality of screw holes 131. The anti-shock members 15 and the casing 11 are respectively formed with a plurality of through holes 155, 1111 corresponding to the screw holes 131, allowing the screws 17 to be inserted into the through holes 1111, 155 and coupled to the screw holes 131, so as to fix the hard disk drive 13 to the casing 11.

However, many anti-shock members 15 are required for the anti-shock device 1, and the anti-shock members 15 are relatively complex in structure, such that the anti-shock device 1 is cost-ineffective to implement. Moreover, the anti-shock device 1 includes many components to be assembled, and thus the assembly process thereof is complex, time-consuming and inefficient, thereby increasing the assembly and maintenance costs of the anti-shock device 1, and making the anti-shock device 1 not desirable in commercial use.

Therefore, the problem to be solved here is to provide a simple structure for fixing a disk drive, which can improve an anti-shock effect for the disk drive.

### SUMMARY OF THE INVENTION

In light of the foregoing drawbacks of the prior art, an objective of the present invention is to provide a disk drive fixing device having a simplified structure.

Another objective of the invention is to provide a disk drive fixing device, which can reduce the number of components being used.

Still another objective of the invention is to provide a disk drive fixing device, which is easy to be assembled.

A further objective of the invention is to provide a disk drive fixing device, which can reduce the material costs and the assembly and maintenance costs thereof.

In order to achieve the foregoing and other objectives, the present invention proposes a disk drive fixing device for carrying and fixing a disk drive on a mounting surface. The disk drive fixing device comprises: a main body comprising a carrying space for carrying at least one disk drive, and at least one fixing portion formed on one side of the main body and for being fixed to the mounting surface; and at least one buffer completely covering the fixing portion, for being fixed to the mounting surface by a fixer, allowing the fixing portion of the main body to be indirectly in contact with the fixer and the mounting surface via the buffer, so as to provide an anti-shock effect for the disk drive indirectly fixed on the mounting surface.

The fixing portion of the main body can be a pin hole formed on a bottom side of the main body, and is capped and completely covered by the buffer. In a preferred embodiment, the main body is formed with a plurality of the fixing portions that are coplanar, such as three or four fixing portions formed on the bottom side of the main body. Moreover, the main body can be a hollow frame having the carrying space, and preferably the hollow frame has at least two slots each for fixing a disk drive. The disk drive can be a hard disk drive or a soft disk drive.

The buffer can be a rim structure. In a preferred embodiment, the buffer can be a rubber rim having a surrounding groove. The surrounding groove is used to cap the fixing portion (such as a pin hole) of the main body. The fixer for fixing the buffer to the mounting surface can be a bolt. The mounting surface where the disk drive fixing device is fixed can be a surface of a server case.

Therefore, the disk drive fixing device according to the present invention involves providing the buffer to completely cover the fixing portion on one side of the main body, and using the fixer to fix the buffer to the mounting surface, such that the fixing portion of the main body can be indirectly in contact with the fixer and the mounting surface via the buffer, thereby providing the anti-shock effect for the disk drive indirectly fixed on the mounting surface. This arrangement simplifies a structural design for providing the anti-shock effect. As the number of buffers being required simply corresponds to the number of fixing portions of the main body, such that the disk drive fixing device of the present invention uses much fewer components that those of the prior art. Moreover, the disk drive fixing device of the present invention is easy to be assembled and requires relatively short assembly time, and is further advantageous of reducing the material costs and the assembly and maintenance costs thereof.

### BRIEF DESCRIPTION OF THE DRAWINGS

The present invention can be more fully understood by reading the following detailed description of the preferred embodiments, with reference made to the accompanying drawings, wherein: FIG. 1 (PRIOR ART) is a schematic exploded diagram of a conventional anti-shock device for a hard disk drive; FIG. 2 (PRIOR ART) is a cross-sectional view of the conventional anti-shock device assembled with the hard disk drive;

FIG. 3 is a schematic exploded diagram of a disk drive fixing device according to a preferred embodiment of the present invention;

FIG. 4 is a schematic exploded diagram of the disk drive fixing device according to the preferred embodiment of the invention being used for carrying and fixing a disk drive on a mounting surface; and

FIG. 5 is a front view of the disk drive fixing device according to the preferred embodiment of the invention, which carries and fixes the disk drive on the mounting surface, wherein a fixing portion of a main body of the disk drive fixing device is indirectly in contact with a fixer and the mounting surface via a buffer of the disk drive fixing device.

### DETAILED DESCRIPTION OF THE PREFERRED EMBODIMENTS

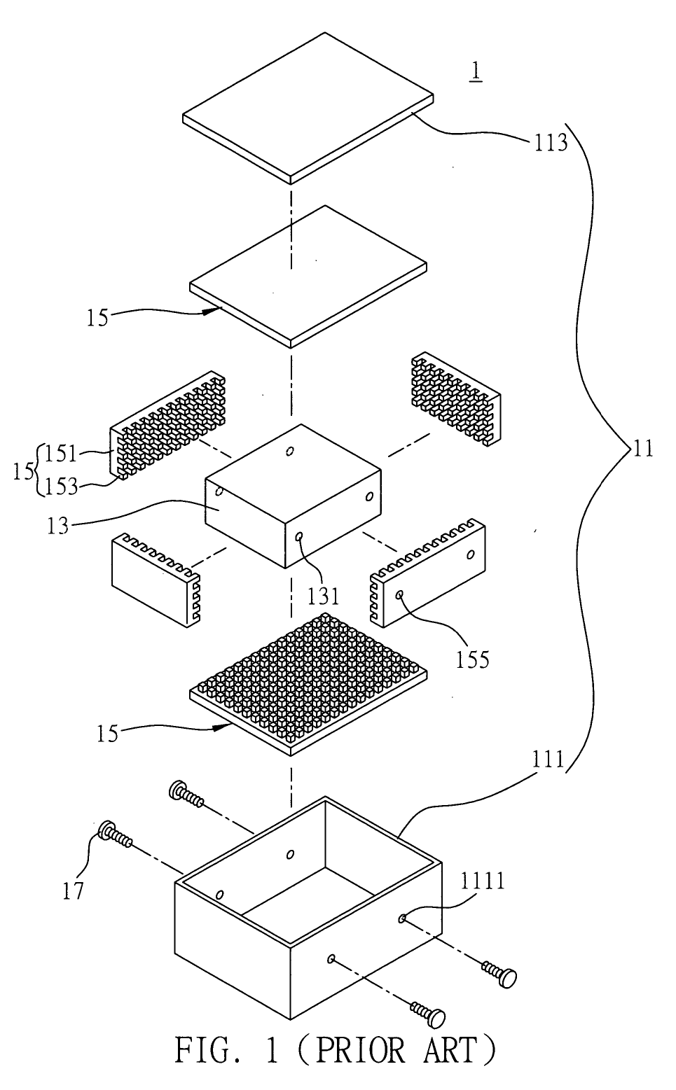

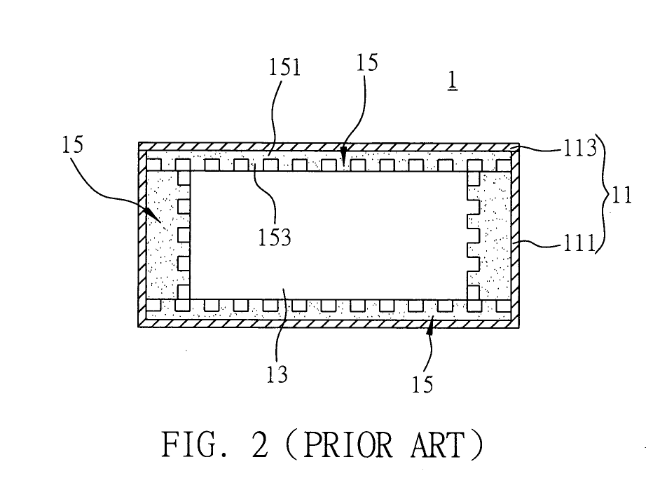

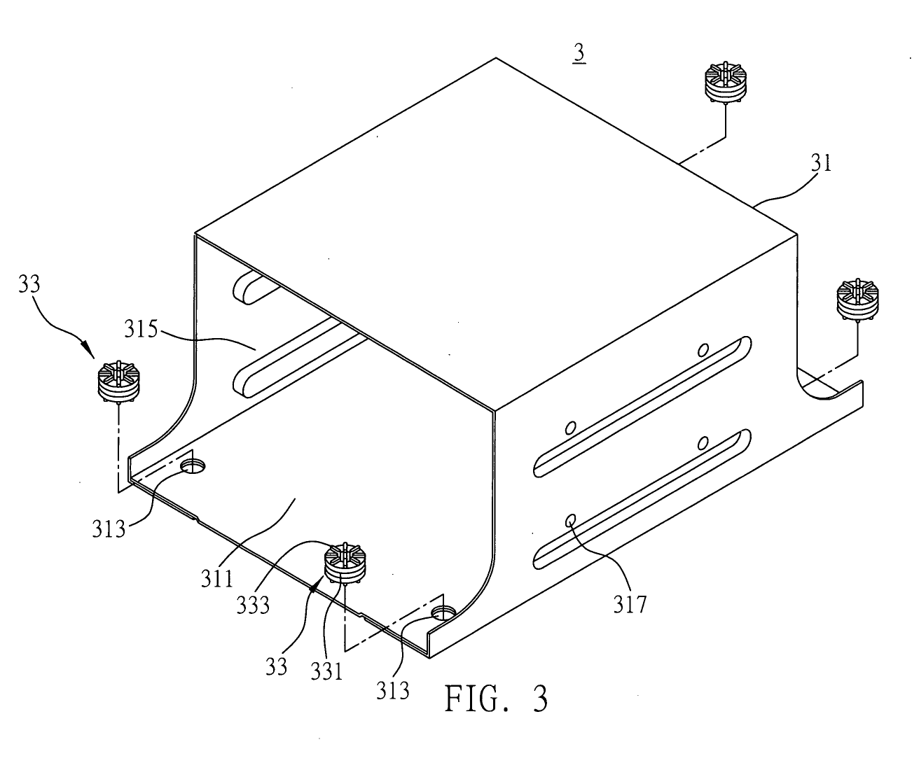

Preferred embodiments of a disk drive fixing device proposed in the present invention are described as follows with reference to FIGS. 3 to 5. It is to be noted that the drawings are simplified schematic diagrams and only show components relating to the present invention. In practice, the layout of components could be more complicated. It should be understood that the following embodiments are not construed to limit the scope of the present invention.

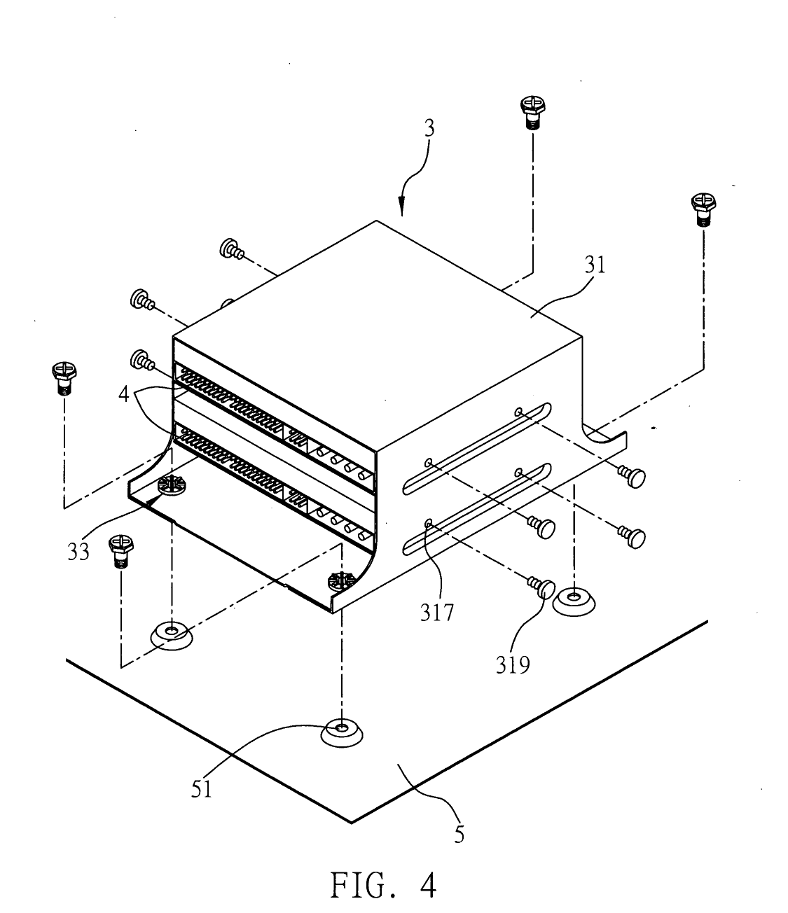

Referring to FIG. 3, a disk drive fixing device 3 according to a preferred embodiment of the present invention is illustrated. As shown in FIG. 3, the disk drive fixing device 3 comprises a main body 31 and at least one buffer 33. Referring to FIG. 4, the disk drive fixing device 3 being used for carrying and fixing at least one disk drive 4 on a mounting surface 5 is illustrated. The disk drive 4 can be a hard disk drive or a soft disk drive, and the mounting surface 5 can be a surface of a server case. It should be noted that the structure and functionality of hard disk drive, soft disk drive, server, and server case are well known in the art, and thus are not to be further described herein. As shown in FIGS. 3 and 4, in the disk drive fixing device 3 of the present invention, the main body 31 comprises a carrying space 311 for accommodating the at least one disk drive 4, and at least one fixing portion 313 formed on one side of the main body 31 and for being fixed to the mounting surface 5. In this embodiment, the main body 31 can a hollow frame having the carrying space 311. The hollow frame has at least two slots 315 each for fixing one disk drive 4. A through hole 317 is formed on each of two sides of the main body 31 at a position corresponding to each of the slots 315, allowing a screw 319 to be inserted into the through hole 317 to fix the disk drive 4. Particularly, the main body 31 comprises a plurality of the fixing portions 313 that are coplanar. The fixing portion 313 is a pin hole formed on a bottom side of the main body 31, and can be capped and completely covered by the buffer 33. It should be noted that the number of the slots 315 is not limited to that shown in the drawings of this embodiment, but can be flexibly modified according to practical needs. The buffer 33 covers the fixing portion 313 completely, and can be fixed to the mounting surface 5 by a fixer 35 such as a bolt, so as to allow the fixing portion 313 of the main body 31 to be indirectly in contact with the fixer 35 and the mounting surface 5 via the buffer 33. The buffer 33 is a rim structure, and in this embodiment, the buffer 33 can be a rubber rim having a surrounding groove 331 and a plurality of protruding portions 333 disposed evenly on a surface thereof. The surrounding groove 331 is used to cap the fixing portion 313, and the protruding portions 333 provide better structural strength and elasticity for the buffer 33. The structure of the buffer 33 can be modified in response to the shape of the fixing portion 313. In other words, the buffer 33 is not limited to a rubber rim having a surrounding groove 331 as in this embodiment, but can be in the form of a rubber rim having a C-shaped groove or any equivalent structure that has any other shape, is made of any other material and can completely cover the fixing portion 313. The fixer 35 can be, but is not limited to, a bolt.

It should be noted that, in this embodiment, there are four fixing portions 313 formed on the bottom side of the main body 31, each of which is capped and covered by the respective buffer 33, and the buffer 33 can be fixed to a screw hole 51 of the mounting surface 5 by the fixer 35, so as to allow the disk drive fixing device 3 of this embodiment to be fixed on the mounting surface 5 and absorb shocks. However, in another preferred embodiment, it is also feasible to form three coplanar fixing portions on the bottom side of the main body, with each of the fixing portions being capped and covered completely by the respective buffer. Therefore, the number, location and arrangement of the fixing portions 313 are not limited to those described in this embodiment.

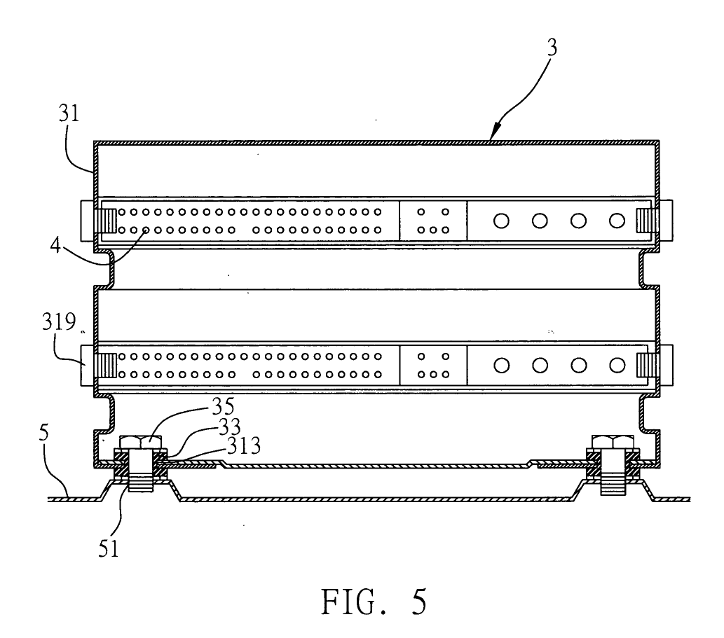

When it is to use the disk drive fixing device 3 to carry and fix the disk drive 4 on the mounting surface 5, the disk drive 4 is positioned in the carrying space 311 of the main body 31, and the fixing portion 313 of the main body 31 is completed covered by the buffer 33, allowing the fixer 35 to be inserted into the buffer 33 and coupled to the screw hole 51 of the mounting surface 5. As such, as shown in FIG. 5, the fixing portion 313 of the main body 31 can be indirectly in contact with the fixer 35 and the mounting surface 5 via the buffer 33, so as to indirectly fix the disk drive 4 on the mounting surface 5 via the disk drive fixing device 3.

Compared with the prior art, the disk drive fixing device according to the present invention involves providing the buffer to completely cover the fixing portion on one side of the main body, and using the fixer to fix the buffer to the mounting surface, such that the fixing portion of the main body can be indirectly in contact with the fixer and the mounting surface via the buffer, thereby providing the anti-shock effect for the disk drive indirectly fixed on the mounting surface. This arrangement provides a simplified structural design for providing the anti-shock effect, thereby solving the prior-art problem. Moreover, as the number of buffers being required simply corresponds to the number of fixing portions of the main body, such that the disk drive fixing device of the present invention uses much fewer components that those of the prior art. Furthermore, the disk drive fixing device of the present invention is easy to be assembled and requires relatively short assembly time, and is further advantageous of reducing the material costs and the assembly and maintenance costs thereof. Therefore, the disk drive fixing device proposed by the invention can overcome the drawbacks of the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A disk drive fixing device for carrying and fixing a disk drive on a mounting surface, the disk drive fixing device comprising:
a main body comprising a carrying space for carrying at least one disk drive, and at least one fixing portion formed on one side of the main body and for being fixed to the mounting surface; and
at least one buffer completely covering the fixing portion, for being fixed to the mounting surface by a fixer, allowing the fixing portion of the main body to be indirectly in contact with the fixer and the mounting surface via the buffer.

2. The disk drive fixing device of claim 1, wherein the fixing portion is a pin hole formed on a bottom side of the main body, and is capped and completely covered by the buffer.

3. The disk drive fixing device of claim 1, wherein the main body is formed with a plurality of the fixing portions that are coplanar.

4. The disk drive fixing device of claim 1, wherein the buffer is a rim structure.

5. The disk drive fixing device of claim 4, wherein the buffer is a rubber rim having a surrounding groove for capping the fixing portion.

6. The disk drive fixing device of claim 5, wherein the fixing portion is a pin hole.

7. The disk drive fixing device of claim 1, wherein the main body is a hollow frame having the carrying space.

8. The disk drive fixing device of claim 7, wherein the hollow frame has at least two slots each for fixing a disk drive.

9. The disk drive fixing device of claim 1, wherein the fixer is a bolt.

10. The disk drive fixing device of claim 1, wherein the mounting surface is a surface of a server case.
